(19) United States
(12) Patent Application Publication
(10) Pub. No.: US 2006/0090827 A1
(43) Pub. Date: May 4, 2006

(54) Tread comprising a ventilated device for countering irregular wear

(75) Inventor: Jose Merino Lopez, Riom (FR)

Correspondence Address: COHEN, PONTANI, LIEBERMAN & PAVANE, 551 FIFTH AVENUE, SUITE 1210, NEW YORK, NY, 10176, US

(73) Assignee: Michelin Recherche et Technique S.A., Granges-Paccot (CH)

(21) Appl. No.: 11/302,880

(22) Filed: Dec. 14, 2005

Related U.S. Application Data
(63) Continuation of application No. PCT/EP04/06335, filed on Jun. 11, 2004.

(30) Foreign Application Priority Data
Jun. 16, 2003 (FR) 03/07231

(51) Int. Cl. B60C 11/01; B60C 11/12; B60C 11/13

(52) U.S. Cl. 152/209.16; 152/209.17; 152/209.18; 152/209.27

(57) ABSTRACT

A tread (B) provided with a tread pattern formed of a plurality of elements in relief (1, 10) which are defined by grooves and/or incisions (2), this tread pattern comprising on each of its edges, that is to say axially furthest to the outside of the tread, an edge rib (1) of circumferential orientation defined axially to the inside by a groove (2) of the same general orientation and of depth H, this tread furthermore comprising, axially to the outside of each edge rib (1), a rib (3) offset relative to the outer contact surface (11) of the neighboring edge rib (1) by a distance d other than zero, this offset rib (3) being separated from the edge rib (1) by a groove (4) of a depth identical or close to the depth H of the groove (2) defining the edge rib (1), wherein the tread comprises, on either side where a sacrificed rib (3) is formed, a plurality of channels (5) opening on to the lateral faces of the tread, these channels (5) being extended in the tread until they open into the groove (4) between the offset rib (3) and the neighboring edge rib (1).

### RELATED APPLICATION

This application is a U.S. Continuation Application under 35 USC 371 of International Application PCT/EP2004/006335 filed Jun. 11, 2004.

### FIELD OF THE INVENTION

The subject of the present invention is an improvement to the tread of tires for heavy vehicles; it relates in particular to treads provided with a tread pattern formed of tread pattern elements essentially in the form of ribs or a combination of blocks and ribs.

This invention is more particularly intended to be used for radial-carcass tires intended for the non-driving axles of heavy vehicles.

### BACKGROUND OF INVENTION

Such tires most frequently comprise a carcass reinforcement surmounted radially to the outside by a crown belt which itself is surmounted by a tread provided with a tread pattern formed essentially of ribs of general circumferential orientation. It is known in particular from U.S. Pat. No. 4,480,671 to provide each of the lateral zones of this tread with a lateral rib axially to the outside of the tread and the meridian profile of which is substantially parallel and radially internal to the meridian profile of the geometric contour forming the geometrical envelope of the principal median zone of the tread. “Radially inner” is to be understood to mean that when new the lateral rib comprises a face radially to the outside which is offset relative to the running surface of the tire. When passing into contact on the roadway, under the action of the supported load, the material constituting the tread is compressed, which brings the lateral rib into contact with the roadway. The initial offset must be sufficient to create contact pressures on this lateral rib while promoting slip relative to the roadway and thus to develop wear preferentially on this rib, thus protecting the edge rib of the tread from irregular wear. It has been noted that the offset is maintained throughout the use of the tread. The average offset used is at least equal to 1 mm and at most equal to 6 mm; this value of the initial offset, that is to say when the tire is new, should of course be adapted according to the nature of the material(s) constituting the tread (rubber mixes) and according to their mechanical properties in compression.

Due to this arrangement, it is possible to keep a sharp edge at the edges of the tread, the rib formed axially to the outside of each of said edges acting as what is called a “sacrificed” rib because it participates only very little in bearing the load of the tire. This sacrificed rib is separated axially from the rib axially furthest to the outside of the tread by a narrow, substantially circular circumferential groove of a depth substantially equal to the depth of the main grooves of the tread defining the ribs of said tread.

This structure has completely demonstrated its effectiveness in use; however, it has been noted that conditions of use have changed substantially and are nowadays more demanding than in the past and that the result is heating within the different rubber mixes of the tread in particular in the vicinity of the axial ends of the reinforcing belt for the crown of the tire and also in the region of the sacrificed rib. This heating resulting from the mechanical stresses due to the traveling conditions result in an additional energy consumption and are also the cause of accelerated ageing of the rubber mixes and a reduction in the fatigue and tear resistance performance of the rubber mixes in particular under the effect of impacts. Use of these tires on heavy vehicles traveling in countries of high average temperature is very adversely affected.

### SUMMARY OF THE INVENTION

The subject of the invention is a tread the structural characteristics of which make it possible to maintain a sacrificed-rib effect preventing the development of irregular wear on the edges of the ribs axially to the outside of the tread, this tread itself being provided with a tread pattern formed of a plurality of grooves of general circumferential orientation defining ribs, this tread when in use having an appropriate, reduced thermal level in order to limit the phenomenon of accelerated ageing of the rubber mixes, and this tread better withstanding impacts against its edges.

A tread according to the invention is defined axially by two lateral faces surrounding a running surface provided with a tread pattern formed of a plurality of elements in relief defined by grooves and/or incisions, this tread pattern comprising on each of its edges, that is to say axially furthest to the outside of the tread, a rib of circumferential orientation delimited axially to the inside by a groove of the same general orientation and of depth H, (the width of the tread corresponds to the axial distance between the axially outermost points of the two edge ribs). This tread furthermore comprises, axially to the outside of each edge rib, a rib offset radially towards the inside relative to the outer contact surface of the neighboring edge rib by a distance d other than zero, this offset rib being separated from the edge rib by a groove extending substantially within the thickness of the tread as far as a depth identical or close to the depth of the groove defining the edge rib. This rib which is offset radially towards the inside is intended to come into contact with the ground during travel; it comprises a face radially to the outside which is intended to come into contact with the ground and two lateral faces, one of which is located axially to the outside of the tread. Furthermore, the tread comprises, on either side where a rib which is offset radially towards the inside is present, a plurality of channels opening on to the lateral faces of said offset ribs, these channels being extended within the tread until they open into the groove present between the offset rib and the neighboring edge rib.

The value of the amount d by which the rib offset radially towards the inside is offset is other than zero and is such that the outer surface of this offset rib is set back relative to the outer contact surface of the neighboring edge rib. This value d is preferably selected so as to permit contact of the offset rib with the ground with a contact pressure substantially less than the contact pressure existing between the other ribs of the tread and the ground. As a general rule, this offset d is at least equal to 1 mm and at most equal to 6 mm. As explained in U.S. Pat. No. 4,480,671, the difference in rolling length between the two ribs (edge and offset) results in braking forces being created on the offset rib and thus makes it possible to concentrate the wear on this rib, protecting the edge rib from irregular wear. “Braking force” is understood to mean a force exerted by the ground on the rib, said force opposing the forward movement of the tire.

The channels preferably have a section equivalent to that of a circular disc of a diameter of between 1.5 mm and 4 mm and even more preferably between 2 and 3 mm.

Furthermore, the presence of these channels makes it possible to reduce the compressive strength of the sacrificed rib upon loading of said rib and thus to reduce the contact pressure, which very substantially improves the effectiveness of this offset rib with regard to the wear of the neighboring edge rib while ensuring better impact resistance. Furthermore, the passage of air into the channels is very favorable to the thermal level of the offset ribs which, owing to their sliding contact with the ground, are subjected to particularly high temperatures compared with what is observed on the other elements in relief of the tread pattern.

Advantageously, at least some of the channels are extended as far as the groove defining axially to the inside the edge rib provided axially to the outside with an offset rib, so as to promote heat exchanges in this part of the tread.

The width of the groove separating an edge rib from an offset rib is preferably less than 3.5 mm for treads intended for tires for transport vehicles of heavy-vehicle type so as to permit contact between the offset rib and the edge rib, be it under the action of the load borne by the tire or under the action of the transverse forces during cornering in order to limit the bending of the ribs.

Advantageously, the average distance between two channels is between one and twelve times the equivalent diameter of the channels, and even more advantageously between two and six times the same diameter in order to avoid the risk of cracking of the material constituting the tread. “Equivalent average diameter” of a channel is understood to mean the diameter of a circular disc of the same surface area as the channel in question. Preferably, the number of channels will be greater for greater widths of sacrificed ribs.

Of course, the channels may be oriented so as to form a zero angle or an angle other than zero with the axial direction. In this latter case, the angle is at most equal to 45°.

### BRIEF DESCRIPTION OF THE DRAWINGS

Other characteristics and advantages of the invention will become apparent from the description given hereafter with reference to the appended drawings, which show, by way of non-limitative examples, forms of embodiment of the subject of the invention.

FIG. 1 shows a localized view of a tread according to the invention comprising an offset rib provided with a plurality of channels;

FIG. 2 shows the same tread along a section taken in a plane II-II;

FIG. 3 shows a variant of a tread according to the invention, the channels being extended as far as the groove defining an edge rib;

FIG. 4 shows a variant of distribution of the channels on the axially outer face of an offset rib;

FIG. 5 shows in section a variant according to the invention in which the channels are inclined so as to move away from the running surface of the tread, moving axially towards the outside;

FIG. 6 shows a variant according to the invention in which the channels are provided on their outer end with a device which promotes the circulation of air.

### DESCRIPTION OF THE PREFERRED EMBODIMENTS

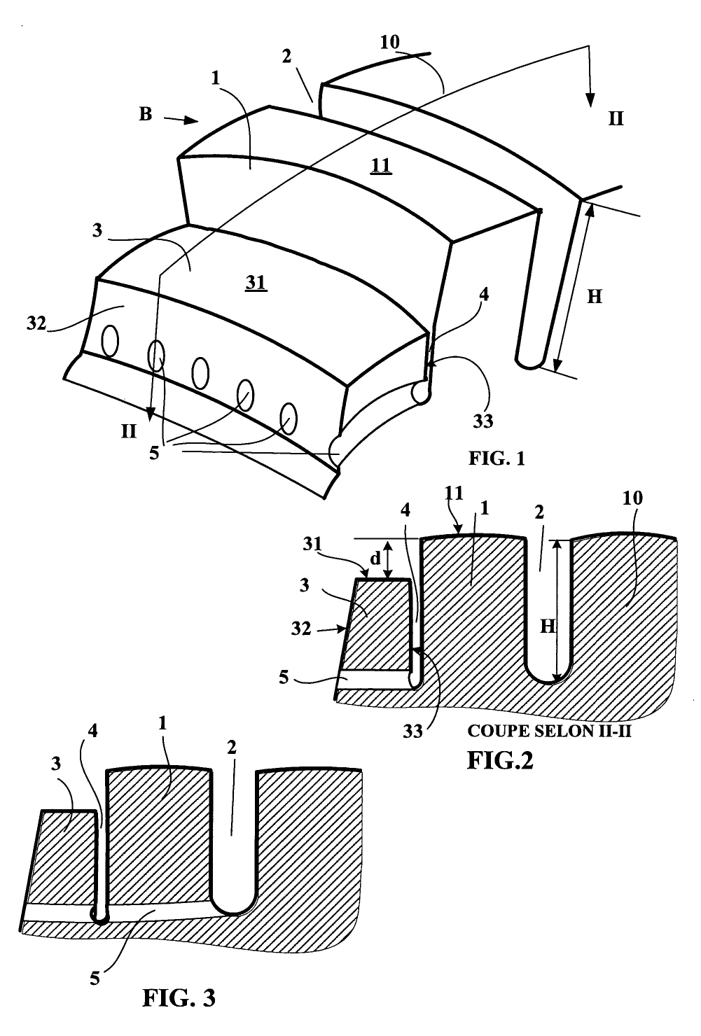

FIG. 1 shows a local view of a tread B according to the invention, for a tire of dimension 315/80 R 22.5, comprising a tread pattern formed by a plurality of main ribs 1, 10 oriented in the circumferential direction, these main ribs 1, 10 being separated from one another by main grooves 2 of circumferential orientation and of depth H and of the same width. FIG. 1 shows an edge of the tread with an edge rib 1 provided axially towards the outside of the tread with an offset rib 3 of a width equal to 7.8 mm, this offset rib 3 being separated from the edge rib by an incision 4 of a width less than 1 mm and having the width of the main grooves 2. This incision 4 is extended in the thickness of the tread to substantially the same depth as the main grooves.

The offset d, which in the case illustrated is equal to 1.4 mm, between the contact face 11 of the edge rib 1 forming part of the running surface of the tread and the outer face 31 of the offset rib 3 is such that, upon loading of the tread under the action of the load borne by a tire fitted with said tread, this outer face 31 also comes into contact with the ground. This effect is desired from the start of use of a new tread or even after initial wear representing a small proportion of the total wear permissible for the tread (it is considered that wear equivalent to 10% of the period of use of the tread is an approximation of this initial wear).

Furthermore, a plurality of channels 5 have been molded beneath the outer surface 31 of the offset rib 3. These channels 5 extend between the faces axially to the outside 32 and axially to the inside 33 of the offset rib 3. In this manner, the incision 4 between the offset rib 3 and the edge rib 1 communicates with the axially outer face 32 of the offset rib.

All these channels 5 have a substantially circular cross-sectional form of a diameter of 3 mm and are spaced apart from one another by an average distance equal to 8.2 mm (or 2.7 times the diameter of the channels).

FIG. 2 shows this same tread viewed in a section taken in a radial plane, that is to say a plane passing through the axis of rotation of the tire provided with this tread. This FIG. 2 and all the other FIGS. 3 to 6 use the same references to indicate comparable elements.

In the case illustrated, the channels 5 are located in planes perpendicular to the longitudinal direction of the tread (these planes are also radial planes) and are arranged so as to be oriented substantially in the axial direction (that is to say the direction of the width of the tread or alternatively of the axis of rotation of the tire).

The offset element 3 has its outer surface 31 set back relative to the outer surface 11 of the rib 1 by an appropriate quantity d to permit contact with the roadway in use. This offset or setback is maintained throughout the period of use of the tire provided with this tread.

In another variant shown in FIG. 3 in section in a radial plane, the channels 5 are extended as far as the main groove 2 adjacent to the edge rib 1. This arrangement ensures even more significantly cooling of the offset rib 3 by the passage of air from the outside of the tread towards the groove (or vice versa).

This flow of air can be improved still further as can be seen with the variant shown in FIG. 6 in which, in addition to the fact that the channels 5 are inclined so as to form an angle a other than zero and less than 45° with the axis of rotation of the tire provided with such a tread, there is also provided a relief 7 on the outer face 32 of the offset rib 3 in the vicinity of each channel outlet 5. This relief 7 is formed preferably on part of the periphery of each channel 5 in order to form a sort of wing to promote circulation of air in each channel 5 and to increase the flow of air, thus ensuring forced ventilation of the offset rib 3 (this relief may be used whether or not the channels are inclined).

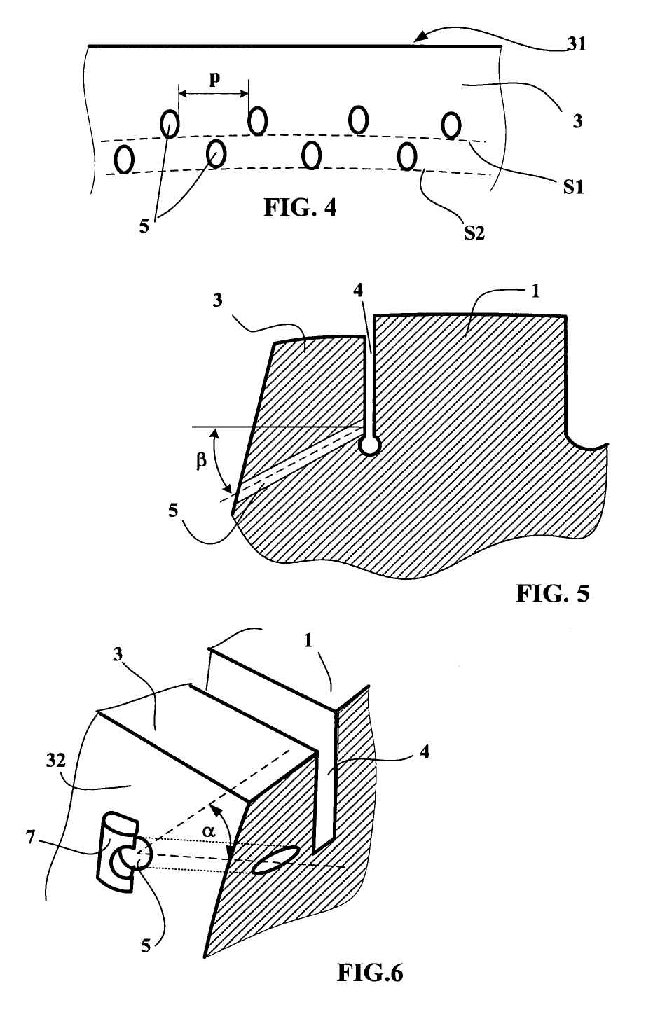

In another variant according to the invention (FIG. 4), channels 5 are placed on two concentric cylindrical surfaces S1 and S2 within an offset element 3; the different channels 5 being placed staggered with a distance P between channels of between one and four times the equivalent section diameter of the channels 5. In this manner, the risk of breaks in the materials in the vicinity of the channels 5 is substantially reduced. “Equivalent diameter” of a channel is understood to mean the diameter of a circular disc of the same surface area as the cross-section of the channel taken in a plane perpendicular to the direction of the largest dimension of said channel.

In another variant (FIG. 5), the channels 5 are located in a radial plane (that is to say a plane passing through the axis of rotation) and inclined by an angle β relative to the axial direction marked X in FIG. 5 so make the parts of the tread located radially to the inside of the offset rib 3 (that is to say at a depth greater than the depth H of the incision 4 defining the offset rib 3) benefit from the ventilation, and hence cooling, effect.

Furthermore, and in order to increase still further the flow of air circulating in the channels, it is possible to modify the geometry of said channels at least in the vicinity of the faces on to which they open (for example by the presence of widened sections).

Generally, a tread according to the invention and the variants described here do not cause any molding difficulty: for this, the process described in the document U.S. Pat. No. 6,408,910 can be used.

The invention is not limited to the examples described and shown, and various modifications can be made thereto without departing from the scope thereof. In particular, the ribs and grooves of the tread pattern may have traces which are not necessarily aligned in the circumferential direction (for example forming zigzags) or alternatively be in a zigzag in the direction of the depth of the tread

Finally, what has been set forth with respect to ribs also applies to tread pattern blocks arranged in rows extending in the circumferential direction.

What is claimed is:

1- A tread defined axially by two lateral faces surrounding a running surface, this tread being provided on its running surface with a tread pattern formed by a plurality of elements in relief which are defined by grooves and/or incisions, this tread pattern comprising on each of its edges, that is to say axially furthest to the outside of the tread, an edge continuous rib of circumferential orientation defined axially to the inside by a groove of the same general orientation and of depth H, wherein this tread furthermore comprises, axially to the outside of each edge rib, a sacrificed rib having a face radially to the outside offset, relative to the outer contact surface of the neighboring edge rib, radially towards the inside by a distance d other than zero, this sacrificed rib being separated from the edge rib by a groove of a depth identical or close to the depth H of the groove defining the edge rib, wherein this tread comprises, on either side where a sacrificed rib is formed, a plurality of channels opening on to the lateral faces of the tread, these channels being extended in the tread until they open into the groove between the offset rib and the neighboring edge rib.

2- The tread according to claim 1 wherein the offset is at least equal to I mm and at most equal to 6 mm.

3- The tread according to claim 2 wherein the channels have an equivalent diameter equal to the diameter of a surface of section equivalent to that of a circular disc, said equivalent diameter being between 1.5 and 4.0 mm.

4- The tread according to claim 3 wherein the average distance between two channels is between twice and six times the equivalent diameter of the channels.

5- The tread according to claim 2 wherein each of the channels is not in a plane perpendicular to the longitudinal direction of the tread and forms an angle a at most equal to 45° with the transverse direction of the tread.

6- The tread according to claim 2 wherein the average width of the groove separating an edge rib from an offset rib is at most equal to 3.5 mm.

7- The tread according to claim 2 wherein at least some of the channels formed in an offset rib are extended as far as the groove defining axially to the inside the neighboring edge rib of said offset rib.

8- The tread according to claim 1 wherein a relief is provided on the outer surface of the sacrificed rib in the vicinity of each channel in order to promote the flow of air within said channel upon rolling.

9- The tread according to claim 1 wherein the channels are arranged staggered, the distance between said channels being between one and four times the diameter of the channels.

10- The tire provided with a tread according to claim 1 wherein it is intended to be fitted on a front axle of a vehicle of heavy-vehicle type.
